(19) United States
(12) Patent Application Publication
(10) Pub. No.: US 2015/0026390 A1
(43) Pub. Date: Jan. 22, 2015

(54) GARBAGE COLLECTION CONTROL METHOD FOR SOLID STATE DRIVE

(71) Applicant: LITE-ON IT CORPORATION, Taipei (TW)

(72) Inventor: Chia-Lun Li, Hsinchu (TW)

(73) Assignee: LITE-ON IT CORPORATION, Taipei (TW)

(21) Appl. No.: 14/027,355

(22) Filed: Sep. 16, 2013

(30) Foreign Application Priority Data
Jul. 17, 2013 (CN) 201310300464.X

(51) Int. Cl. G06F 12/02

(52) U.S. Cl. CPC G06F 12/0246; G06F 12/0253
USPC 711/103

(57) ABSTRACT

A garbage collection control method for a solid state drive includes the following steps. Firstly, when a garbage collection is started by the solid state drive, a type of a write command from a host is judged. If the write command is not a sequential write command, a first type garbage collection is performed for obtaining a released space smaller than one free block space from a flash memory, and the write command is executed to store a write data into the flash memory. If the write command is the sequential write command, a second type garbage collection is performed for obtaining a released space larger than one free block space from the flash memory, and the write command is executed to store the write data into the flash memory.

This application claims the benefit of People's Republic of China Application Serial No. 201310300464.X, filed Jul. 17, 2013, the subject matter of which is incorporated herein by reference.

### FIELD OF THE INVENTION

The present invention relates to a control method for a solid state drive, and more particularly to a garbage collection control method for a solid state drive.

### BACKGROUND OF THE INVENTION

As is well known, a solid state drive (SSD) is a data storage device that uses a NAND-based flash memory to store data. The NAND-based flash memory is a non-volatile memory. After data are written to the flash memory, if no power is supplied to the flash memory, the data are still retained in the flash memory.

FIG. 1 is a schematic functional block diagram illustrating a conventional solid state drive. As shown in FIG. 1, the solid state drive 10 comprises a controlling unit 101 and a flash memory 105. The flash memory 105 is accessible by the controlling unit 101 through an internal bus 107. In addition, the controlling unit 101 is in communication with a host 12 through an external bus 20. Consequently, commands and data can be exchanged between the controlling unit 101 and the host 12. Moreover, the external bus 20 is a USB bus, an IEEE 1394 bus, an SATA bus, or the like.

Generally, the flash memory 105 comprises plural blocks. Each block comprises plural pages (or sectors), for example 64 pages. Each page is typically 4K bytes in size. Due to the inherent properties of the flash memory 105, at least one page is written at a time during the writing operation, but a block is erased during the erasing operation.

Basically, the block without any stored data is referred as a free block, and the block with the stored data is referred as a used block. In case that the data of a used block are all invalid data, the used block may be erased as a free block. Consequently, the free block can be used to store data again.

However, after the flash memory 105 has been accessed for a long time, each block of the flash memory 105 may contain some valid data and some invalid data. As long as the used block contains the valid data, the used block fails to be erased as the free block. Since the space of the flash memory 105 is occupied by a great number of invalid data, the writable space of the flash memory 105 is gradually reduced.

As the number of used blocks in the flash memory 105 gradually increases and the number of free blocks in the flash memory 105 gradually decreases, it is necessary to perform a garbage collection. Generally, when the number of free blocks in the flash memory 105 decreases to a threshold number, the garbage collection is started by the controlling unit 101. After the garbage collection is performed, the storing space of the invalid data in the used blocks can be released. Consequently, the write data inputted by the host 12 can be continuously stored into the flash memory 105.

FIG. 2 schematically illustrates a conventional process of performing a garbage collection. As shown in FIG. 2, the data D1 of the used block c (Block_c) are valid data, the data D2 of the used block c (Block_c) are invalid data, and the block d (Block_d) is a free block. While the garbage collection is performed on the used block c (Block_c) by the controlling unit 101, the valid data D1 of the used block c (Block_c) are firstly moved to the free block d (Block_d) and refreshed as the valid data D1′. After the valid data D1′ is written into the free block d (Block_d), the free block d (Block_d) becomes another used block d (Block_d). Then, all data in the used block c (Block_c) are set as invalid data. Afterwards, the used block c (Block_c) is erased as a new free block c (Block_c). Meanwhile, one garbage collection is completed.

In other words, after the garbage collection is performed, the block c (Block_c) becomes a new free block. Moreover, the used block d (Block_d) still has other free space B for storing data. That is, after the garbage collection is performed, the free space B is a released space for allowing the host 12 to continuously store data. The size of the free space B is smaller than the size of one free block.

Since the released space obtained by the conventional garbage collection is smaller than one free block space, if the amount of data to be written into the flash memory 105 from the host 12 is very large, the efficiency of the conventional garbage collection is usually unsatisfactory.

### SUMMARY OF THE INVENTION

An embodiment of the present invention provides a garbage collection control method for a solid state drive. The garbage collection control method includes the following steps. Firstly, when a garbage collection is started by the solid state drive, a type of a write command from a host is judged. If the write command is not a sequential write command, a first type garbage collection is performed for obtaining a released space smaller than one free block space from a flash memory, and the write command is executed to store a write data into the flash memory. If the write command is the sequential write command, a second type garbage collection is performed for obtaining a released space larger than one free block space from the flash memory, and the write command is executed to store the write data into the flash memory.

Another embodiment of the present invention provides a solid state drive. The solid state drive is in communication with a host. The solid state drive includes a flash memory and a controlling unit. The flash memory includes plural blocks. The controlling unit is used for receiving a write command from the host, and storing a write command into the flash memory. When a garbage collection is started, the controlling unit judges a type of the write command. If the write command is not a sequential write command, a first type garbage collection is performed for obtaining a released space smaller than one free block space from the flash memory, and the write command is executed to store the write data into the flash memory. If the write command is the sequential write command, a second type garbage collection is performed for obtaining a released space larger than one free block space from the flash memory, and the write command is executed to store the write data into the flash memory.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating a conventional solid state drive;

FIG. 2 (prior art) schematically illustrates a conventional process of performing a garbage collection;

FIG. 3 schematically illustrates a process of performing a garbage collection according to an embodiment of the present invention; and

FIG. 4 is a flowchart illustrating a garbage collection control method for a solid state drive according to an embodiment of the present invention.

### DETAILED DESCRIPTION OF PREFERRED EMBODIMENTS

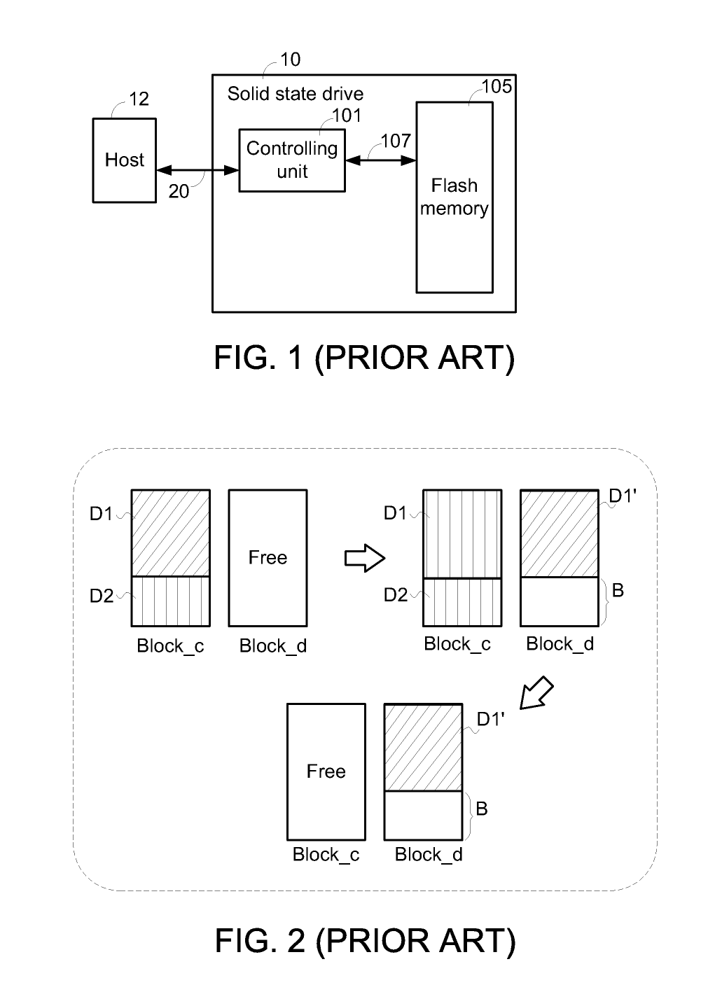

The present invention provides a garbage collection control method for a solid state drive. The method of the present invention may be applied to the solid state drive with the architecture as shown in FIG. 1. It is noted that the applications of the method of the present invention are not restricted to the solid state drive of FIG. 1.

As previously described, after the conventional garbage collection is performed, the size of the released space is smaller than the space of a block. If the amount of data to be written into the flash memory 105 by the host 12 is small, the released space obtained by the conventional garbage collection is sufficient to store the data from the host 12. However, if the amount of data to be written into the flash memory 105 by the host 12 is large (e.g. larger than the space of a free block), the released space obtained by the conventional garbage collection is insufficient to store the data from the host 12. Under this circumstance, the controlling unit 101 should perform the conventional garbage collection many times in order to obtain more released space to store the write data from the host 12. Consequently, the time period of writing data into the solid state drive 10 increases, and the writing efficiency is impaired.

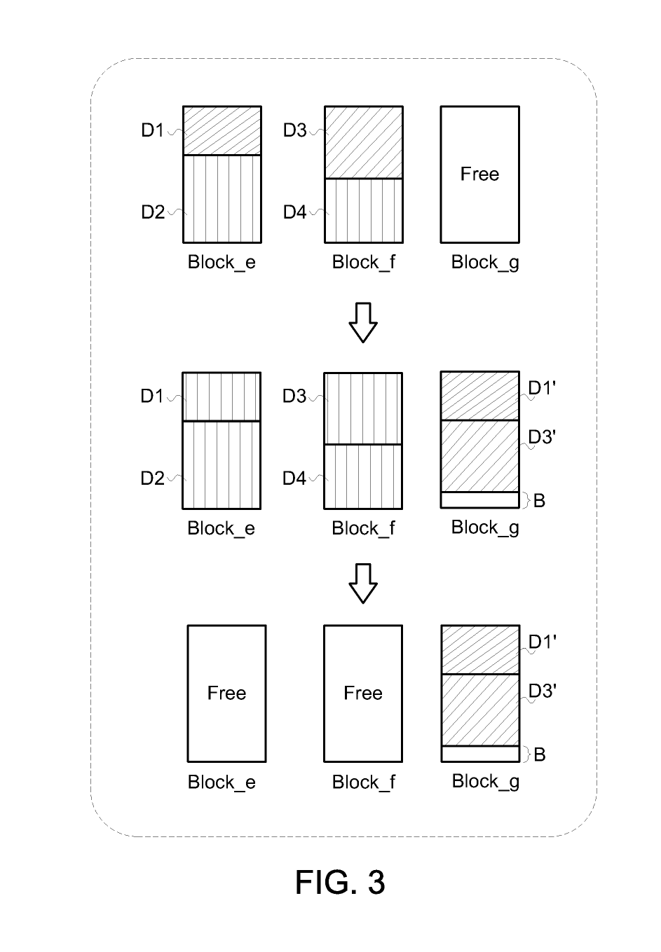

FIG. 3 schematically illustrates a process of performing a garbage collection according to an embodiment of the present invention. As shown in FIG. 3, the data D1 of the used block e (Block_e) are valid data, and the data D2 of the used block e (Block_e) are invalid data. The data D3 of the used block f (Block_f) are valid data, and the data D4 of the used block f (Block_f) are invalid data. In addition, the block g (Block_g) is a free block.

When the garbage collection of the present invention is performed by the controlling unit 101, the data D1 of the used block e (Block_e) and the data D3 of the used block f (Block_f) are firstly moved to the free block g (Block_g) and refreshed as the valid data D1′ and D3′, respectively. Then, all data in the used block e (Block_e) and the used block f (Block_f) are set as invalid data. Afterward, the used block e (Block_e) and the used block f (Block_f) are erased as two new free blocks e (Block_e) and f (Block_f). Meanwhile, one garbage collection of the present invention is completed.

In other words, after the garbage collection of the present invention is performed, the block e (Block_e) and the block f (Block_f) become two new free blocks. Moreover, the used block g (Block_g) still has other free space B for storing data. That is, after the garbage collection of the present invention is performed, the released space comprising a whole free block and the free space B may be provided for allowing the host 12 to continuously store data. The size of the released space is larger than the size of one free block space.

From the above descriptions, for performing the garbage collection of the present invention, the valid data in two used blocks are transferred and stored into a free block, and then the two used blocks are erased. In comparison with the conventional garbage collection, the garbage collection of the present invention can at least release one complete block as the released space.

In some embodiments, the controlling unit 101 may search M used blocks with low valid data counts from the flash memory 105, then transfer and store the valid data of the M used blocks into a free block, and finally erase the M used blocks as M free blocks. Consequently, the garbage collection of the present invention can at least release (M−1) complete blocks as the released space for allowing the host 12 to continuously store data.

Obviously, in comparison with the conventional garbage collection, the garbage collection of the present invention can obtain more space for allowing the host 12 to continuously store data.

However, while the garbage collection of the present invention is performed, the controlling unit 101 has to search more information about the valid data of more used block and move the valid data of more used block. Consequently, the time period of performing the garbage collection of the present invention is longer than that of the conventional garbage collection.

According to the characteristics of the above two types of garbage collections, the present invention provides a garbage collection control method for a solid state drive. In this context, the conventional garbage collection is referred as a first type garbage collection, and the garbage collection of the present invention is referred as a second type garbage collection.

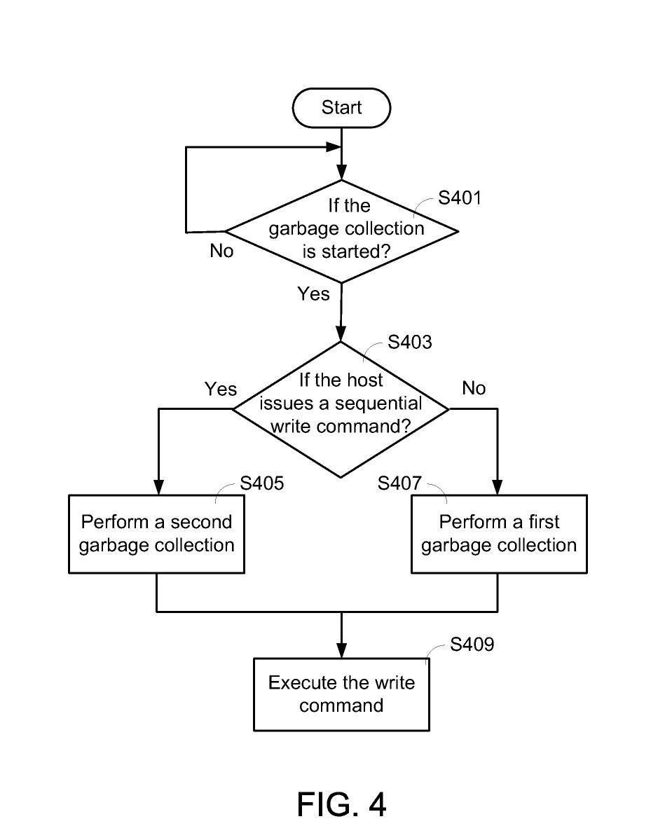

FIG. 4 is a flowchart illustrating a garbage collection control method for a solid state drive according to an embodiment of the present invention. When the solid state drive 10 is in a normal working state, the controlling unit 101 may store write data into the flash memory 105 according to the write command from the host 12. Consequently, the number of used blocks will gradually increase, and the number of free blocks will gradually decrease.

When the number of free blocks in the flash memory 105 decreases to a threshold number, the garbage collection is started by the controlling unit 101 (Step S401). Otherwise, the solid state drive 10 continuously waits for the timing of starting the garbage collection. It is noted that the timing of starting the garbage collection by the controlling unit 101 is not restricted. For example, at the time when a ratio of the number of used blocks to the number of free blocks in the flash memory 105 reaches a threshold ratio, the garbage collection is started by the controlling unit 101.

Generally, when the host 12 issues a write command, the write command may be determined as a sequential write command or a random write command according to a logical block address (LBA) from the host 12. For example, if the write command from the host 12 intends to store a write data into k consecutive logical block addresses (e.g. LBA_1˜LBA_k) and the amount of the write data exceeds a specified data amount, the write command from the host 12 is determined as the sequential write command.

Otherwise, the write command from the host 12 is determined as the random write command. It is noted that the specified data amount may be set according to the practical requirements. For example, the specified data amount is set as the space of one block or 80% space of one block.

In an embodiment, if the controlling unit 101 judges that the host 12 issues a sequential write command (Step S403), the second type garbage collection is performed (Step S405). After the second type garbage collection is performed, the write command from the host 12 is executed (Step S409).

On the other hand, if the controlling unit 101 judges that the write command from the host 12 is not a sequential write command (Step S403), the first type garbage collection is performed (Step S407). After the first type garbage collection is performed, the write command from the host 12 is executed (Step S409).

From the above discussions, if the write command from the host 12 is the random write command, the amount of the write data is not very large. Under this circumstance, the first type garbage collection is performed by the controlling unit 101 in order to obtain a released space smaller than one free block space to store the write data. After the write command is executed by the controlling unit 101, the write data is stored into the released space of the flash memory 105. Consequently, the task corresponding to the write command can be quickly implemented.

On the other hand, if the write command from the host 12 is the sequential write command, the amount of the write data is usually larger than one free block space. Under this circumstance, the second type garbage collection is performed by the controlling unit 101 in order to obtain a released space larger than at least one free block space to continuously store the write data. After the write command is executed by the controlling unit 101, the write data is stored into the released space of the flash memory 105. In other words, at least one free block is used for storing a portion of the write data, so that the free block becomes a first used block. In case that the write data according to the sequential write command is refreshed, all data in the first used block are set as invalid data. Consequently, the controlling unit 101 only has to erase the first used block without the need of performing the garbage collection on the first used block. In other words, the time period of performing the garbage collection by the controlling unit 101 can be reduced.

From the above descriptions, the present invention provides a garbage collection control method for a solid state drive. In accordance with the present invention, the first type garbage collection or the second type garbage collection is selectively performed according to the sequential write command or the random write command provided from host 12. As a consequence, the controlling unit 101 can manage the flash memory 105 more efficiently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures

What is claimed is:

1. A garbage collection control method for a solid state drive, the garbage collection control method comprising steps of:
(a) judging a type of a write command from a host when a garbage collection is started by the solid state drive;
(b) if the write command is not a sequential write command, performing a first type garbage collection for obtaining a released space smaller than one free block space from a flash memory, and executing the write command to store a write data into the flash memory; and
(c) if the write command is the sequential write command, performing a second type garbage collection for obtaining a released space larger than one free block space from the flash memory, and executing the write command to store the write data into the flash memory.

2. The garbage collection control method as claimed in claim 1, wherein when the number of free blocks in the flash memory decreases to a threshold number, the garbage collection is started.

3. The garbage collection control method as claimed in claim 1, wherein if the write command from the host intends to store the write data into plural consecutive logical block addresses and an amount of the write data exceeds a specified data amount, the write command is the sequential write command.

4. The garbage collection control method as claimed in claim 1, wherein the step of performing the first type garbage collection comprises sub-steps of:
(b1) selecting a first used block from plural blocks of the flash memory, wherein the first used block stores a first-portion valid data and a second-portion invalid data;
(b2) moving the first-portion valid data of the first used block to a free block of the flash memory; and
(b3) erasing the first used block.

5. The garbage collection control method as claimed in claim 1, wherein the step of performing the second type garbage collection comprises sub-steps of:
(c1) selecting a first used block and a second used block from plural blocks of the flash memory, wherein each of the first used block and the second used block stores a first-portion valid data and a second-portion invalid data;
(c2) moving the first-portion valid data of the first used block and the first-portion valid data of the second used block to a free block of the flash memory; and
(b3) erasing the first used block and the second used block.

6. A solid state drive in communication with a host, the solid state drive comprising:
a flash memory comprising plural blocks; and
a controlling unit for receiving a write command from the host, and storing a write data into the flash memory,
wherein when a garbage collection is started, the controlling unit judges a type of the write command, wherein if the write command is not a sequential write command, a first type garbage collection is performed for obtaining a released space smaller than one free block space from the flash memory, and the write command is executed to store the write data into the flash memory, wherein if the write command is the sequential write command, a second type garbage collection is performed for obtaining a released space larger than one free block space from the flash memory, and the write command is executed to store the write data into the flash memory.

7. The solid state drive as claimed in claim 6, wherein when the number of free blocks in the flash memory decreases to a threshold number, the garbage collection is started.

8. The solid state drive as claimed in claim 6, wherein if the write command from the host intends to store the write data into plural consecutive logical block addresses and an amount of the write data exceeds a specified data amount, the write command is determined as the sequential write command by the controlling unit.

9. The solid state drive as claimed in claim 6, wherein while the first type garbage collection is performed by the controlling unit, a first used block storing a first-portion valid data and a second-portion invalid data is selected from the plural blocks of the flash memory, then the first-portion valid data of the first used block is moved to a free block of the flash memory, and finally the first used block is erased.

10. The solid state drive as claimed in claim 6, wherein while the second type garbage collection is performed by the controlling unit, a first used block and a second used block each storing a first-portion valid data and a second-portion invalid data are selected from the plural blocks of the flash memory, then the first-portion valid data of the first used block and the first-portion valid data of the second used block are moved to a free block of the flash memory, and finally the first used block and the second used block are erased.
